(19) United States
(12) Patent Application Publication
(10) Pub. No.: US 2006/0156908 A1
(43) Pub. Date: Jul. 20, 2006

(54) Keyboard instrument

(76) Inventor: Takashi Yoshimine, Saitama (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/563,283

(22) PCT Filed: Jun. 21, 2004
(86) PCT No.: PCT/JP04/08717

§ 371 Date: Jan. 3, 2006

(51) Int. Cl. G10H 7/00; H02M 5/00

(52) U.S. Cl. 84/619

(57) ABSTRACT

[OBJECT] To provide a keyboard instrument that is easy for a beginner to use and less in the cost.

[MEANS FOR SOLVING] A keyboard instrument 10 includes a keyboard portion 4 constituted only of keyboards 21 in which tone intervals are arranged so as to repeat an arrangement of whole step, whole step, half step, whole step, whole step, whole step and half step. That is, without disposing black keyboards that can alienate a beginner from a keyboard instrument 10, the respective keyboards 21 are arranged. Thereby, while securing the respective keyboards 21 necessary for performing a piece of music, a beginner is allowed lightheartedly addressing a keyboard instrument 10 and playing readily. Since the number of keyboards 21 preparing for manufacturing a keyboard instrument 10 can be reduced, the lower cost can be achieved.

### FIELD OF THE INVENTION

The present invention relates to a keyboard instrument having a keyboard.

### BACKGROUND OF THE INVENTION

So far, a keyboard of a keyboard instrument is constituted by repeating an arrangement of white keys and black keys in order of white, black, white, black, white, white, black, white, black, white, black and white. A tone interval of each of the arranged keyboard is set at a half step and the tone intervals of the respective white keys are set so as to repeat an arrangement of whole step, whole step, half step, whole step, whole step, whole step and half step. A keyboard instrument such as an acoustic piano or the like that has strings is constituted so that, when a keyboard is touched a hammer strikes a string to generate a sound, and when a finger is detached from the keyboard a damper goes down to damp the string and thereby to stop vibrations. An electronic keyboard instrument such as an electric piano is constituted so that, by making use of digital data of sounds, sounds are generated from a sound source. Thus, keyboard instruments of which almost all persons from beginners to advanced players can make use are in market.

Some of the electronic keyboard instruments are provided with an automatic transposing device (function) for transposing a key of a piece of music. For instance, in patent literature 1, an automatic transposition device having a transposition information setting unit for setting transposition information of a whole of a keyboard instrument and a transposition excluded part setting unit for setting a part that is not transposed is disclosed. When information such as the number of degrees of transposition is set in the automatic transposition setting unit and transposition excluded part setting unit, desired transposition is performed. Furthermore, the electronic keyboard instrument has an automatic player capable of, for instance, memorizing and reproducing data played by a player.

Patent literature 1: JP-A No. 09-319368 (paragraph and FIG. 1)

### DISCLOSURE OF INVENTION

### Problems to be Solved

However, since in the keyboard instrument according to the patent literature 1 a white key and a black key are arranged in a repeating manner, it is difficult for a beginner to lightheartedly utilize it. Furthermore, when, for instance, a beginner transposes a piece of music of which chord is other than a C chord to the C chord to reproduce, transposition information has to be set to transpose. Accordingly, there is a problem in that a beginner can use it with difficulty.

In view of the above situations, the present invention intends to provide a keyboard instrument that can be readily used by a beginner and is less expensive.

### MEANS FOR SOLVING THE PROBLEM

In order to achieve the above object, a keyboard instrument, comprising: a keyboard portion made only of keyboards in which tone intervals are arranged so as to repeat an arrangement of whole step, whole step, half step, whole step, whole step, whole step and half step; and a support portion that supports the keyboard portion.

In the invention, a keyboard portion is constituted only of keyboards in which tone intervals are arranged so as to repeat an arrangement of whole step, whole step, half step, whole step, whole step, whole step and half step. That is, without disposing keyboards (for instance, black keyboards) that can alienate a beginner from a keyboard instrument, keyboards are arranged. Thereby, while securing keyboards necessary for performing a piece of music, a beginner is allowed lightheartedly addressing a keyboard instrument and can readily play. Since the number of keyboards preparing for manufacturing a keyboard instrument can be reduced, the lower cost can be achieved.

Now, the keyboard portion is an assembly of individual keyboards. The support portion has, for instance, a support member that supports the individual keyboards from below or a casing partially accommodating the individual keyboards.

According to the present invention, the keyboards are all in the same color. According to such a configuration, when all the keyboards are made white keyboards, a beginner can cope with a keyboard instrument same as coping with a percussion instrument, and since there is no need of preparing keyboards of different colors and shapes when manufacturing a keyboard instrument lower cost can be realized.

According to the present invention, the keyboard instrument further comprising: a first storing means for storing an information of sounds of a piece of music, a setting means for setting a first key information that is an information on a destination of transposition of the piece of music, a second storing means for storing the first key information set by the setting means, a judging means for judging a second key information that is a key of the piece of music based on the information of sounds of a piece of music stored by the first storing means, and a transposing means for transposing sounds of the piece of the music stored by the first storing means to sounds corresponding to the first key information based on the second key information judged by the judging means. Now, the information of sounds of the piece of music includes information of, for instance, sounds used in the piece of music and the frequency of use of the sounds. According to such a configuration, when a user of a keyboard instrument sets information of a key of a destination of transposition of the piece of music, a key of the piece of music can be automatically transposed to a set key. Accordingly, since a user is not necessary to set information such as the number of steps to transpose the key of the piece of music, it becomes particularly easier for a beginner to use. Furthermore, it becomes possible to play at the same key while simultaneously hearing the piece of music transposed to the set key. At that time, it is preferable to prepare in advance a transposed musical score. Thereby, the performance at the transposed key becomes easier.

According to the present invention, the keyboard instrument further comprising: a first storing means for storing an information of sounds of a piece of music and a first key information that is a key of the piece of music, a setting means for setting a second key information that is an information on a destination of transposition of the piece of music, a second storing means for storing the second key information set by the setting means, a transposing means for transposing sounds of the piece of the music stored by the first storing means to sounds corresponding to the second key information based on the second key information stored by the second storing means. According to such a configuration, since the information of the key of the piece of music is stored in advance, there is no need of judging the key of the piece of music. Accordingly, in comparison with a case where a key of a piece of music is judged from information of sounds of the piece of music, an accurate and rapid transposition can be performed.

According to the present invention, the keyboard instrument further comprising: a performance support plate that is disposed on the keyboards slidable in a plane where the keyboards are arranged.

According the present invention, the keyboard instrument further comprising: a performance support plate disposed turnable so as to be attachable to or detachable from the keyboards.

When thus configured, for instance, the performance support plate can be slid or turned during the performance to superpose on the respective keyboards and thereby utilized to perform. Accordingly, the performance can be more readily carried out. Furthermore, at the end of the performance, the performance support plate is once more slid or turned to arrange only for instance white keyboards, and thereby a space formed on the keyboards can be effectively used.

According to the present invention, the performance support plate has a black keyboard, a color keyboard, a scale keyboard or a numerical keyboard. The black keyboard, scale keyboard and numerical keyboard, respectively, are ones obtained by marking black keyboard marks, sound names and numerals on a transparent sheet disposed for instance slidable or turnable. The color keyboard is for instance a slidable and turnable translucent sheet and is colored so that when the translucent sheet is slid or turned to superpose on the respective keyboards, the respective keyboards may appear in different colors. Thereby, in accordance with a taste of a player, the performance support plate can be utilized; accordingly, the performance can be more readily carried out.

According to the present invention, the keyboard instrument further comprising: an automatic performance unit capable of being placed on the support portion: wherein the automatic performance unit has a storing means for an information of a piece of music, a plurality of key touch devices disposed so as to be touchable with each of the keyboards from thereabove and a controller that control each of the key touch devices based on the information of the piece of music. When thus configured, the respective keyboards can be pressed from the above by use of the respective key touch portions. Accordingly, subtle sounds like ones when a player actually strikes a keyboard can be generated. At this time, by controlling amounts of movement and speeds of the respective key touch portions, more delicate dynamics of sounds can be generated. The automatic performance portion, being able to attach by placing on the support portion of the keyboard instrument or detach therefrom, is excellent in the versatility. There is no need of disposing the automatic performance portion inside of the keyboard instrument; accordingly, the lower cost can be achieved.

According to the present invention, the keyboard instrument further comprising: a vibratable string disposed corresponding to each of the keyboards, a hammer that strikes a string in conjunction with a touched one of the keyboards, a pedal mechanism for shifting the hammer by a half step to each of the strings. Thereby, beginners can play with a keyboard alone and, for instance, average players can play with a pedal to output sounds shifted by a half step.

According to the present invention, he keyboard instrument further comprising: a damper pedal for keeping the string vibrated once being struck with the hammer, wherein the pedal mechanism includes, a first pedal that is disposed on a lower pitch sound side than the damper pedal in a direction of an arrangement of the keyboards and can make sounds of the keyboard lower a half step, and a second pedal that is disposed on a higher pitch sound side than the damper pedal in a direction of an arrangement of the keyboards and can make sounds of the keyboard higher a half step. Thereby, when a right side of the keyboards seen from a player is a higher pitch sound side and a left side of the keyboards seen from a player is a lower pitch sound side, for instance a left leg of the player can be used to make a sound of a touched keyboard a half step lower, and right leg can be used to make a sound of a touched keyboard a half step higher. Accordingly, a pedal operation instinctive to a player can be made possible and the performance with the first and second pedals can be readily achieved.

According to the present invention, the hammer is capable of shifting by use of the first pedal toward a lower pitch sound side in a direction where the respective strings are arranged and by use of the second pedal toward a higher pitch sound side in a direction where the respective strings are arranged. Accordingly, a mechanism similar to an existing shifting pedal where a hammer is shifted in a direction of arrangement of the respective strings, for instance, to make the sound lower, can be used in a pedal mechanism for shifting a hammer by a half step, resulting in achieving the lower cost.

According to the present invention, the hammer is capable of turning by use of the first pedal toward a lower pitch sound side around an axis substantially perpendicular to a direction where the respective strings are arranged and by use of the second pedal toward a higher pitch sound side around the axis. Thus, by use of both legs, touched sounds can be made a half step higher or lower.

### EFFECTS OF THE INVENTION

As mentioned above, according to the invention, by constituting a keyboard portion only of a keyboard in which tone intervals are arranged so as to repeat an arrangement of whole step, whole step, half step, whole step, whole step, whole step and half step, a keyboard instrument that can be readily used by a beginner and is low in the cost can be provided.

### BEST MODE FOR CARRYING OUT THE INVENTION

In what follows, embodiments according to the invention will be described with reference to the drawings.

FIGS. 1, 2 and 3 are a block diagram, a front view and a partial plan view showing an electronic keyboard instrument according to a first embodiment according to the invention.

A keyboard instrument 10 according to the embodiment includes a CPU (Central Controller) 1 for controlling an entirety of the keyboard instrument 10. The CPU 1 is connected through the respective internal interfaces to a ROM (Read Only Memory) 2 in which a control program and PCM (Pulse Code Modulation) data are memorized, a RAM (Random Access Memory) 3 that becomes a work area of the CPU 1 and is capable of storing information of a piece of music inputted from the outside of the keyboard instrument 10 and information of a key of a piece of music set by a setting panel 11 described later and a sound source circuit 7 capable of simultaneously generating a plurality of sounds. In the information of the piece of music stored in the RAM 3, information of, for instance, sounds used in the piece of music inputted from the outside of the keyboard instrument 10 and frequencies of how many times the sound is used is included.

The sound source circuit 7 is connected through a D/A (Digital/Analog) converter omitted from showing in the drawing and an amplifier 8 to a speaker 9. The keyboard instrument 10 includes a keyboard portion 4 for inputting sounds. The keyboard portion 4 has a plurality of keyboards 21 for indicating timings or the like of sounds that are produced or silenced (FIG. 2). The keyboard portion 4 is connected through a keyboard portion interface circuit 5 that scans the on/off of the respective keyboards 21 to detect operated keyboards 21 to the CPU 1 or the like.

The CPU 1 or the like is connected through an internal interface to a setting panel 11 capable of setting a key that is a destination of transposition. For instance, when a user operates a keyboard instrument 10 to input to set a key of a piece of music that the keyboard instrument 10 reproduces, the setting panel 11 is used. The setting panel 11 is provided with, for instance, operation buttons not shown in the drawing, and when a user operates the operation buttons the CPU1 sets a destination of the transposition. The CPU 1 or the like is connected through the internal interface to an automatic transposition program memory 6 where an automatic transposition program is memorized.

The automatic transposition program, by discriminating a key of a piece of music inputted outside of the keyboard instrument 10 and, based on information of sounds stored in the RAM 3, transposing the sounds of the discriminated key to sounds of a key set by the setting panel 11, is used to transpose a key. As the piece of music inputted outside of the keyboard instrument 10, a piece of music inputted when for instance a user strikes a keyboard 21 can be considered. In what follows, this is called an initial setting. However, when the user is a beginner, it is difficult for the beginner to input a certain piece of music. Accordingly, in this case, the user, irrespective of a tempo or the like of the piece of music, has only to strike a keyboard and input one sound at a time. In this case, the user may input while seeing a musical score. As the musical score at this time, musical scores that can be used in the keyboard instrument 10 according to the embodiment have only to be prepared in advance.

As shown in FIGS. 2 and 3, the keyboard instrument 10 includes a keyboard portion 4 and a support portion 17 capable of supporting the keyboard portion 4. The keyboard portion 4 is constituted only of keyboards 21 arranged in an X-direction so that musical intervals may repeat an arrangement of whole step, whole step, half step, whole step, whole step, whole step and half step. The individual keyboards 21 are all set in the same color, for instance, in white, and there is no black keyboard. Although an example where all the keyboards are in the same color is shown, keyboards 21 corresponding to, for instance, [do] may be colored differently from other keyboards, or colors of keyboards of individual octaves may be differentiated from each other. Furthermore, a position of a keyboard 21 for generating a keynote of a key that is a destination of the transposition set by the setting panel 11 is preferably set at a position of a central do of the keyboard portion 4. The position may be marked with a mark or made luminescent so as to be apparently obvious.

On a top surface of the support portion 17, on a remote side in a Y-direction seen from the respective keyboards 21 side, a housing portion 18 where a performance support plate 15 for supporting performances is housed is disposed. The performance support plate 15 is disposed on the respective keyboards 21 slidably in a Y-direction from an initial setting position S in a plane where the respective keyboards 21 are arranged. The performance support plate 15, when slid in a Y-direction, can be moved to a space on the respective keyboards 21 to superpose on the keyboards 21. The performance support plate 15 is one in which on a transparent sheet for instance, sound names such as [do, re, mi, fa, sol, la, si, do] are marked. For instance, in place of the sound names, transparent sheets on which black keyboard marks or numerals are marked respectively may be used, or a colored translucent sheet that can be seen in a different color when slid and superposed on the respective keyboards 21 may be used. Furthermore, colors of the respective keyboards 21 themselves may be similarly changed.

In the next place, an operation of the keyboard instrument 10 will be explained with reference to the drawings. Steps after the initial setting was over and the information of a key of a destination of the transposition was set in advance from the setting panel 11 and stored in the RAM 3 will be described. The beginners preferably set a destination of the transposition at, for instance, [C major] that is easy to play.

As shown in FIG. 4, in a step 10, the CPU 1, by use of information of sounds of a piece of music and the frequencies of use of sounds stored in the RAM 3 according to an automatic transposition program, discriminates a key of an inputted piece of music. For instance, when information of inputted sounds is selected in a decreasing order of the frequencies by 8, musical intervals of the selected respective sounds are calculated, and the musical intervals are whole step, whole step, half step, whole step, whole step, whole step and half step, it is judged as a major key. On the other hand, when musical intervals between the similarly selected respective sounds are whole step, half step, whole step, whole step, half step, whole step and whole step, it is judged as a minor key.

In a step 11, a sound lowest in the pitch of the information of 8 sounds is judged as a keynote. Thereby, a key of the piece of music is judged as, for instance, [E major].

In a step 12, sounds of a key of the piece of music judged in the steps 10 and 11 are shifted to sounds of a key set at the setting panel 11 to transpose. For instance, when a key of a destination of transposition set by the setting panel 11 is [C major] and a key of the piece of music judged in the steps 10 and 11 is [E major], an amount corresponding to four half steps is set to shift.

As mentioned above, according to the embodiment, the keyboard instrument 10 includes the keyboard portion 4 made only of the keyboards 21 arranged so that the musical intervals may repeat an arrangement of whole step, whole step, half step, whole step, whole step, whole step and half step. That is, without disposing the black keyboards that may hold beginners off the keyboard instrument 10, the respective keyboards 21 are arranged. Thereby, while securing the respective keyboards 21 necessary for performing a piece of music, the beginners can be made so as to lightheartedly address the keyboard instrument 10 and to be able to readily play. Since the number of the keyboards 21 prepared to manufacture the keyboard instrument 10 can be reduced, the lower cost can be realized.

In the embodiment, colors of the respective keyboards 21 are all the same. When thus configured, the beginner can address the keyboard instrument 10 same as addresses a percussion, and since there is no need of preparing the keyboards 21 of different colors and shapes for manufacturing the keyboard instrument 10, the lower cost can be realized. In the embodiment, an electronic keyboard instrument 10 is exemplified. However, in the case of a keyboard instrument such as an acoustic piano or the like, the number of the keyboards, the hammers that strike the strings when the keyboards are touched and strings can be reduced, the lower cost can be achieved.

In the embodiment, information or the like of a key set by the setting panel 11 is stored and the automatic transposition program performs the automatic transposition. Thereby, the user, without setting information of the number of degrees for transposition, can easily transpose. Accordingly, the player, while hearing the performance of the transposed piece of music, can play at the same key. At this time, a transposed musical score is preferably prepared in advance. Thereby, since the player can play while seeing the musical score prepared in advance, the performance can be more easily carried out.

In the embodiment, the performance support plate 15 is disposed on the respective keyboards 21 slidably in a Y-direction in a plane where the respective keyboards 21 are arranged. Accordingly, during the performance, the performance support plate 15 can be slid and superposed on the respective keyboards 21, and thereby the performance support plate 15 can be used to perform. Accordingly, the performance can be more easily carried out. Furthermore, when the performance is over, by effectively making use of a space on the respective keyboards 21, the performance support plate 15 can be slid again to take shelter. That is, since there is no black keyboard, the performance support plate 15 can be readily slid.

FIG. 5 is a front view showing a keyboard instrument shown in FIG. 2 and FIG. 6 is a block diagram showing an automatic player of a keyboard instrument.

As shown in FIG. 5, a keyboard instrument 30 according to the embodiment is provided with an automatic player 50 capable of automatically playing a piece of music. The automatic player 50 is disposed by placing on a top surface of a support portion 17. The automatic player 50 includes a casing 51 placed on a top surface of the support portion 17 and a plurality of key touch portions 52 disposed respectively touchable with the respective keyboards 21 from the above. In order that the automatic player 50 may be stably supported on the top surface of the support portion 17, it is preferable that on a lower end surface of the casing 51, a synthetic resin member is disposed so as to inhibit the automatic player 50 from displacing or a concave portion is disposed on the top surface of the support portion 17.

In the casing 51, as shown in FIG. 6, there are a CPU 57 for controlling an entirety of the automatic player 50, a RAM 53 that becomes a work area of the CPU 57, a ROM 54 in which a control program, PCM data and information of pieces of music are stored and an interface circuit 56 that moves the key touch portions 52 up and down according to an instruction from the CPU 57. The respective key touch portions 52 are made of, for instance, a magnetic material, formed into a cylindrical shape and wound around by a coil. It is constituted so that when a voltage applied to the coil is controlled by the CPU 57, the respective key touch portions 52 are moved up and down to push the respective keyboards 21 from the above. Accordingly, as if a player actually strikes keyboards 21, delicate sounds can be generated. At this time, when the CPU 57 controls an amount and speed of displacement of the respective key touch portions 52, a more delicate accent of sounds can be generated. Since the automatic player 50 can be attached by disposing on the support portion 17 or detached, it is excellent in the versatility. Since there is no need of disposing the automatic player 50 inside of the keyboard instrument 30, there is no need of remodeling the keyboard instrument by a specialist. Accordingly, the lower cost can be achieved.

FIG. 8 is a front view showing a pedal mechanism of a keyboard instrument according to a third embodiment and FIG. 9 is a side view showing an interior of a keyboard unit. FIG. 11 is a plan view partially showing the keyboard unit shown in FIG. 9. In the third embodiment, ones similar to members and functions of the keyboard instrument 10 according to the first embodiment are simplified in the description or omitted from describing, and descriptions will be given with a focus on different points.

A keyboard instrument 100 includes a pedal mechanism 70 capable of transposing sounds by a half step and a keyboard unit 80 (FIG. 9) operable by the pedal mechanism 70.

The pedal mechanism 70 includes a damper pedal 71, a first pedal 72 disposed on a lower pitch sound side (for instance, on a left side) than the damper pedal 71 in a direction of arrangement of keyboards 85 of a keyboard portion 180, and a second pedal 73 disposed on a higher pitch sound side (for instance, on a right side) than the damper pedal 71 in a direction of arrangement of keyboards 85.

The first pedal 72 is connected to, for instance, one end of a wire 75 and the other end of the wire 75 is connected to a left side of the keyboard unit 80. The wire 75 is housed in a pipe 76. When the first pedal 72 is touched, the wire 75 is pulled in an arrow mark B direction and thereby the keyboard unit 80 is moved by a half step in a left direction C.

The second pedal 73 is connected to, for instance, one end of a wire 77, and the other end of the wire 77 is connected to a right side of the keyboard unit 80. The wire 77 is housed in a pipe 78. When the second pedal 73 is touched, the wire 77 is pulled in an arrow mark D direction and thereby the keyboard unit 80 is shifted by a half step in a right direction E.

As shown in FIG. 9, the keyboard unit 80 is provided with; a keyboard portion 180; a support member 81 supporting the keyboard portion 180; a string striking mechanism 82; and a damper mechanism 90. The string striking mechanism 82 and the damper mechanism 90 are configured into well-known structures, and these are disposed for each of the keyboards 85. The string striking mechanism 82 includes; an elliptic plate-like hammer 82a (82b, 82c) for generating sounds by picking strings 91, 92 and 93 (94 through 96, 97 through 99) (FIG. 11) corresponding to one keyboard 85; a support rod 82e for supporting these hammers 82a or the like; a pivoting member 82f for pivoting one end of the support rod 82e so that the hammer 82a or the like may go up when a player touches a keyboard; and a rod member 82g for elevating a hammer 82a side of the support rod 82e in conjunction with the keyboard 85 upon touching the keyboard. The rod member 82g is configured so as to operate in conjunction with a movement of the keyboard 85 as described later.

The damper mechanism 90 includes; a damper 90a that comes into contact with strings 91, 92 and 93 to damp a vibration thereof; a wire 90b connected to the damper 90a; and a turn member 90c that is connected to a lower end of the wire 90 and, when the keyboard 85 is touched by the player, comes into contact with an end 85a of the keyboard 85 to be thrust up. Furthermore, the damper mechanism 90 is disposed for each of the keyboards 85 as mentioned above, and all of the damper mechanisms 90 are mechanically connected through a thrust-up rod 74 to the damper pedal 71. Thereby, when the player treads the damper pedal 71, the thrush-up rod 74 is thrush up in an arrow mark A direction (FIG. 8) and thereby all of the damper mechanisms 90 operate to detach the respective dampers 90a from the string 91.

In the next place, operations when the keyboard 85 is touched and the damper pedal 71 is trod will be described.

As shown in FIG. 10, when the keyboard 85 is touched, simultaneously with the uprise of the end 85a, one end of the rod member 82g goes up, and the other end of the support rod 82e goes up. The uprise of the rod member 82g is restricted by a bottom surface of the pivoting member 82f. Integrally with the support rod 82e, the hammer 82g goes up to strike a string, thereafter the hammer 82a descends to detach from the string 91. The end 85a that goes up when the keyboard is touched turns a turn member 90c and thrushes up the damper 90a together with the wire 90b so as to detach the damper 90a from the string 91. Thereby, while the keyboard 85 is being touched, the string 91 keeps on vibrating. When the player releases the keyboard 85, the end 85a descends and the turn member 90c descends. In conjunction with the descent of the turn member 90c, the damper 90a descends integrally with the wire 90b to come into contact with the string 91. On the other hand, when the damper pedal 71 is trod, the thrush-up rod 74 goes up and all turn members 90c corresponding to the all keyboards 85 turn and go up. Simultaneously with the uprise of the turn member 90c, the damper 90a goes up integrally with the wire 90b to disengage from the string 91. When the player releases the damper pedal 71, the thrush-up rod 74 descends and the turn member 90c or the like descends. In conjunction with the descent of the turn member 90c or the like, the damper 90a descends integrally with the wire 90b to come into contact with the string 91. That is, while the damper pedal 71 is being trod, even in a state where the keyboard is not touched, the string 91 and the damper 90a keep a state isolated from each other and thereby sounds once generated can be resounded.

In the next place, operations when the second pedal 73 is used will be described. FIG. 12 is an enlarged plan view when a second pedal 73 in the vicinity of a hammer 82a in a keyboard instrument 100 is used.

As shown in FIG. 11, when the second pedal 73 is not used, for instance three strings 91, 92 and 93 are disposed immediately above a hammer 82a, three strings 94, 95 and 96 are disposed immediately above a hammer 82b and three strings 97, 98 and 99 are disposed immediately above a hammer 82c. At that time, for instance, when the player touches a keyboard 85 corresponding to the hammer 82a and treads the second pedal 73, as shown in FIG. 12, relative to the respective strings, the respective hammers are shifted by a half step toward a high-pitch sound (right direction E). That is, the hammer 82a strikes the strings 94, 95 and 96. As shown in FIG. 13, when the player touches a keyboard 86 and treads the first pedal 72, a sound of a keyboard 87 (normally a black keyboard) that is not actually disposed but used to generate a sound by a half step lower than a sound of the keyboard 86 can be generated. When the player touches the keyboard 85 and treads the second pedal 73, a sound of the keyboard 87 can be generated. Thus, sounds shifted by a half step from sounds of the keyboards disposed at a whole sound interval can be generated.

As mentioned above, the keyboard instrument 100 according to the embodiment is provided with a pedal mechanism 70 that shifts a hammer 82a by a half step toward a lower pitch side or a higher pitch side relative to the string 91. Accordingly, a beginner can play, without using pedals 71, 72 and 73, only with the keyboard 85, and for instance a medium player or higher can play by using legs to shift a sound by a half step up or down.

The keyboard instrument 100 according to the embodiment includes a first pedal 72 disposed on a lower pitch sound side than the damper pedal 71 in a direction of arrangement of the keyboard 85 and a second pedal 73 disposed on a higher pitch sound side than the damper pedal 71 in a direction of arrangement of the keyboard 85. Accordingly, during the performance, with the damper pedal 71 disposed at the center, the first pedal 72 and the second pedal 73, respectively, are positioned on a left side and a right side thereof. Accordingly, since left and right legs, respectively, can be corresponded to make the pitch of a sound by a half step higher or lower, intuitive play can be realized and thereby the first and second pedals 72 and 73 can be easily used to play.

In the embodiment, when the first pedal 72 is trod, the hammer 82a or the like can be shifted through the wire 75 to a lower pitch sound side in a direction where the strings 91 or the like are arranged, and when the second pedal 73 is trod, the hammer 82a or the like can be shifted through the wire 77 to a higher pitch sound side in a direction where the strings 91 or the like are arranged. Accordingly, since a mechanism similar to a well-known shifting pedal that moves a hammer in a direction of arrangement of the respective strings so as to make a pitch of sound lower for instance can be used in the pedal mechanism 70, the lower cost can be achieved.

FIG. 14 is an enlarged plan view showing a pedal mechanism of a keyboard instrument according to a fourth embodiment.

In the embodiment, a hammer 82b is disposed turnable by a half step toward a low pitch sound side and a high pitch sound side around a turn axis 101 perpendicular in a direction in which the strings 91 and so on are arranged. A tip end portion of the hammer 82b is connected to one end of the wire 105 and the other end of the wire 105 is connected to the first pedal 72. Furthermore, the tip end portion of the hammer 82b is connected to one end of the wire 106 and the other end of the wire 106 is connected to the second pedal 73. Incidentally, other hammers are similarly constituted.

In the embodiment, when a player treads the first pedal 72, the hammer 82b can be turned by a half step toward a lower pitch sound side around the turn axis 101, and when the player treads the second pedal 73, the hammer 82b can be turned by a half step toward a higher pitch sound side around the turn axis 101. Even when constituted like this, similarly, by use of the first and second pedals 72 and 73, a touched sound can be made a half step higher or lower.

The invention, without restricting to the above-mentioned embodiments, can be variously modified.

For instance, the keyboard instrument may include; a ROM in which information of sounds of pieces of music and keys thereof is stored in advance and that is omitted from showing in the drawing; and an automatic transposition program having only a step 12 of the automatic transposition program according to the first embodiment. The automatic transposition program at this time is used to automatically transpose the information of sounds of pieces of music stored in the ROM, based on the information of keys of the pieces of music stored in the ROM, to sounds of keys set in the setting panel 11. According to such a configuration, since the information of keys of the pieces of music is stored in advance in the ROM, different from the first embodiment, there is no need of judging the keys of the pieces of music. Accordingly, since it can be inhibited that owing to the inaccuracy in the judgment of a key of a piece of music the transposition cannot be correctly carried out, assured and rapid transposition can be carried out.

In the first embodiment, an example is exemplified where an automatic transposition program that uses sounds used in the pieces of music and the frequencies of use thereof is used to transpose. However, a transposition program is not restricted thereto. For instance, by paying attention to a fact that a keynote is frequently at the beginning or end of a piece of music, the keynote may be judged from sounds at the beginning or end of the piece of music. Furthermore, similarly to the embodiment, a key of a piece of music is judged, and in order to judge whether the judgment of the key is correct or not sounds at the beginning or end of the piece of music may be used.

In the first embodiment, an example where in the step 10 whether the piece of music is a major key or not is judged and in the step 11 a keynote is judged is shown. However, after judging the keynote whether the piece of music is a major key or not may be judged.

In the first embodiment, an example where at the initial setting, a user, by striking keyboards in the keyboard portion 4 to play a piece of music, inputs information of the piece of music is exemplified. However, an inputting device is not restricted thereto. For instance, as shown in FIG. 1, a microphone 12 capable of inputting information of a piece of music outside of the keyboard instrument 10 or a CD-ROM drive omitted from showing in the drawing may be connected through a sampler portion that converts sounds into digital data and is omitted from showing in the drawing to the keyboard instrument 10. By sampling sounds inputted from the microphone 12 or a CD of the not shown CD (Compact Disk)-ROM drive followed by similarly judging a key based on the information of sounds and transposing, a similar advantage can be obtained.

In the first embodiment, an example where information of a key of a destination of transposition set at the setting panel 11 and information of sounds of a piece of music are stored in the same RAM 3 is exemplified. However, information of a key set at the setting panel 11 and information of sounds of a piece of music may be stored in different RAMs.

In the second embodiment, the automatic player 50 having a ROM 54 where information of pieces of music is stored is exemplified. However, without imparting the information of the pieces of music to the ROM 54, by use of information of pieces of music stored by externally inputting in the RAM 3, automatic performance can be carried out. When implementing like this, the automatic player can be reduced in the cost.

In the second embodiment, an example where individual key touch portions 52 are magnetically moved up and down is shown. However, the key touch portion 52 may be moved up and down owing to a driving mechanism such as a cylinder drive due to for instance air pressure, water pressure or oil pressure, or a linear motor. Also by implementing like this, similarly delicate sounds can be generated.

In the above embodiments, an example having an automatic transposition program is shown. However, the setting panel 11 may be provided with a manual transposition setting portion. When thus implemented, it is possible for a user of a keyboard instrument to calculate the number of degree of the transposition to manually transpose, and the player, while hearing a piece of transposed music, can play in the same key.

In the above embodiments, a slidably disposed performance support plate 15 is exemplified. However, without restricting to this, as shown in FIG. 7 for instance, in the case of an acoustic piano 40 or the like, a performance support plate 26 disposed turnable coaxially with a turn axis X of a cap 45 so as to detach the respective keyboards 21 may be used. Thereby, since when the performance support plate 26 is turned to superpose on the respective keyboards 21 the performance support plate can be utilized, the beginners are allowed to play readily.

In the above embodiments, the invention is shown with examples where the keyboard instruments 10, 30 have the automatic transposition program and the performance support plate 15. However, these may be constituted without the automatic transposition program and the performance support plate 15.

In the above embodiments, examples where the invention is applied to an electronic keyboard instrument are shown. However, it goes without saying that the invention may be applied to an acoustic keyboard instrument.

### BRIEF DESCRIPTION OF THE DRAWINGS

FIG. 1 is a block diagram showing an electronic keyboard instrument according to a first embodiment of the invention.

FIG. 2 is a front view showing a keyboard instrument according to the first embodiment.

FIG. 3 is a partial plan view showing the keyboard instrument shown in FIG. 2.

FIG. 4 is a flow chart of an automatic performance program.

FIG. 5 is a front view showing the keyboard instrument shown in FIG. 2.

FIG. 6 is a block diagram showing an automatic player of the keyboard instrument according to a second embodiment of the invention.

FIG. 7 is a side view showing a modification example of a performance support plate of the keyboard instrument according to the first and second embodiments.

FIG. 8 is a front view showing a pedal mechanism of a keyboard instrument according to a third embodiment of the invention.

FIG. 9 is a side view showing an interior of a keyboard unit of the keyboard instrument shown in FIG. 8.

FIG. 10 is an enlarged plan view of the interior of the keyboard unit when a hammer strikes a string.

FIG. 11 is an enlarged plan view before a second pedal in the vicinity of a hammer in the keyboard instrument is used.

FIG. 12 is an enlarged plan view when the second pedal in the vicinity of a hammer in the keyboard instrument is used.

FIG. 13 is a diagram for explaining an operation owing to use of the second pedal in the vicinity of the hammer in the keyboard instrument.

FIG. 14 is an enlarged plan view showing a pedal mechanism of a keyboard instrument according to a fourth embodiment of the invention.

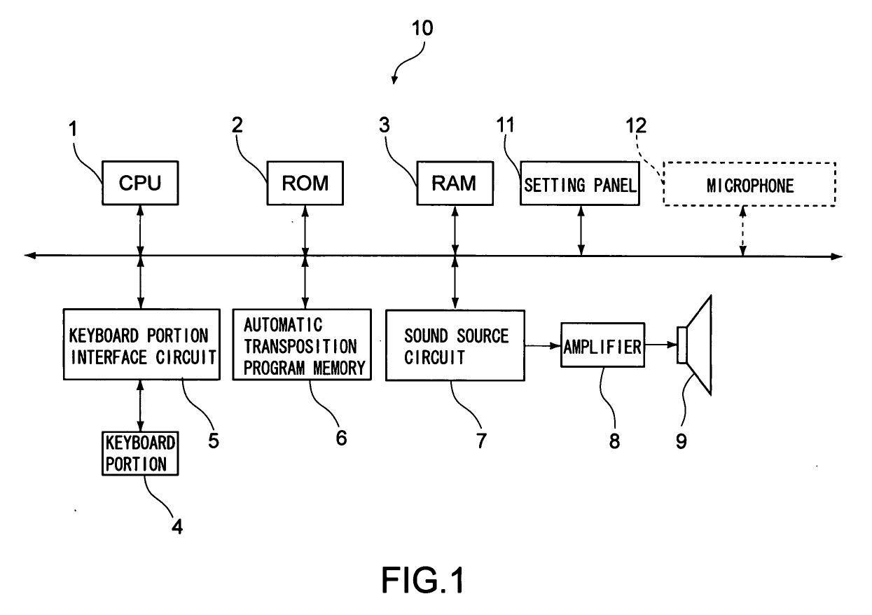

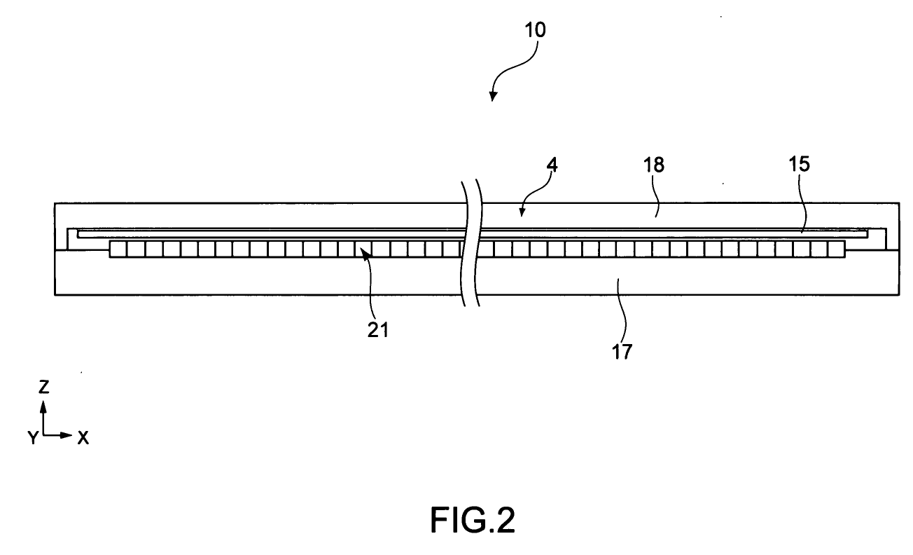

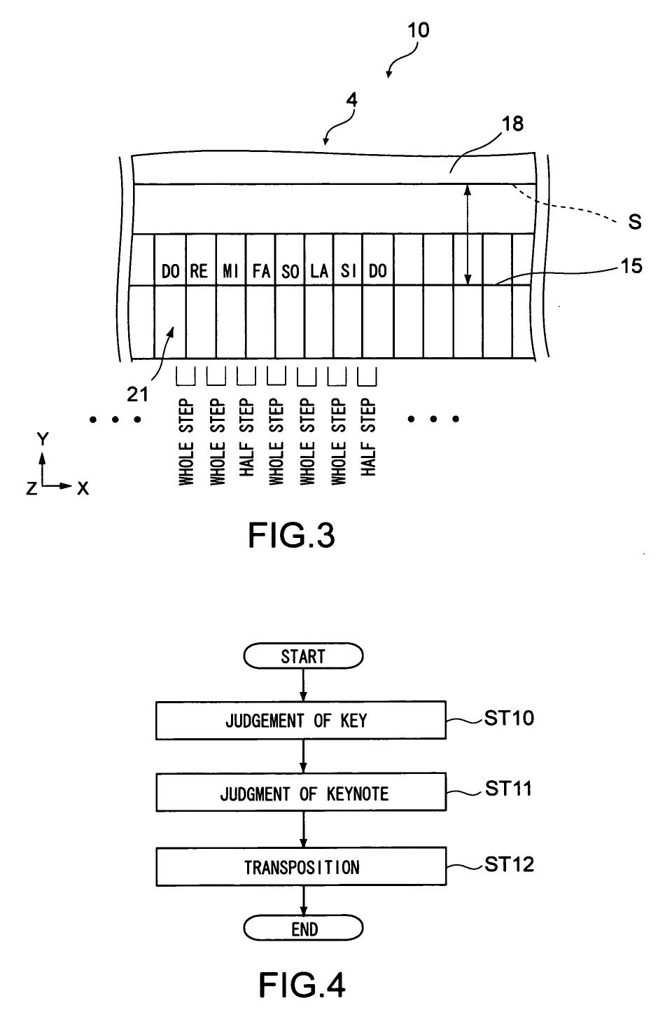

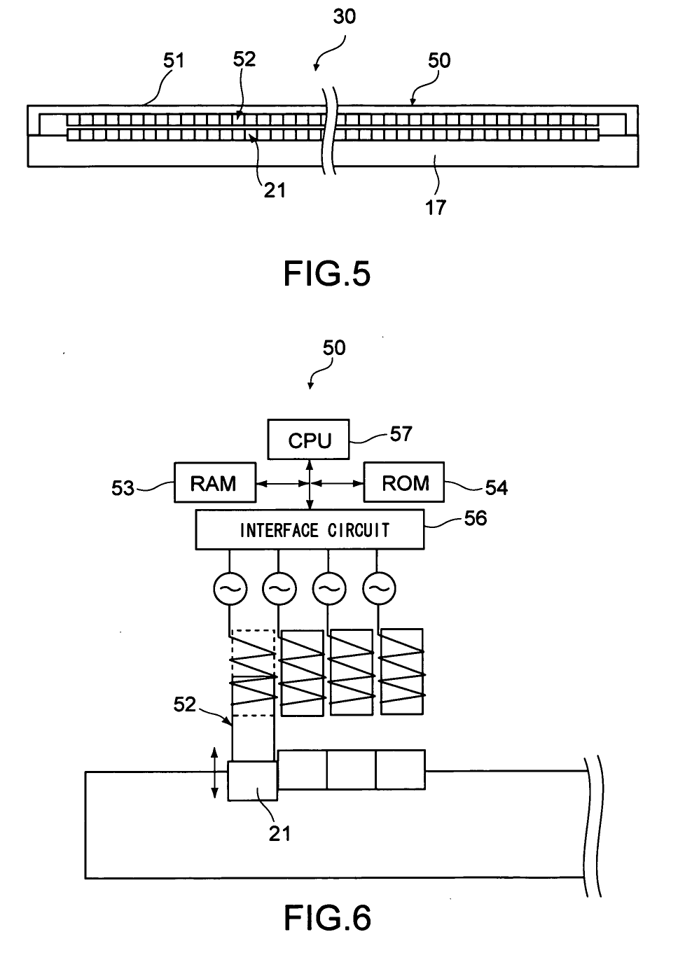

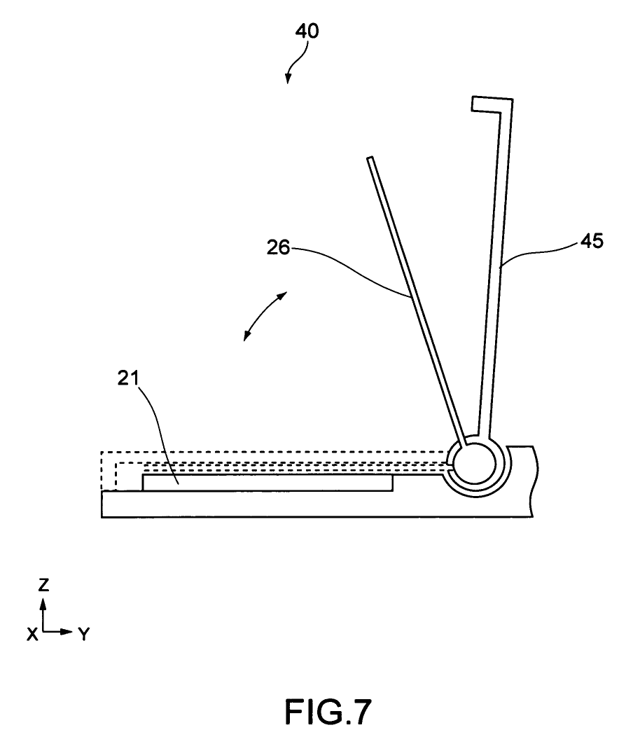

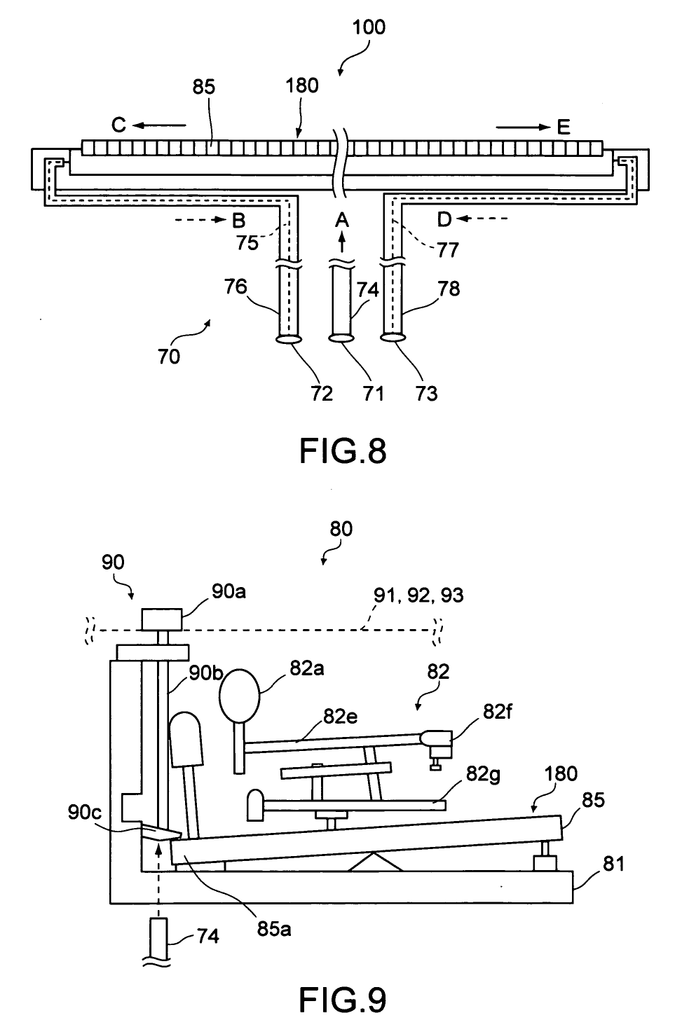

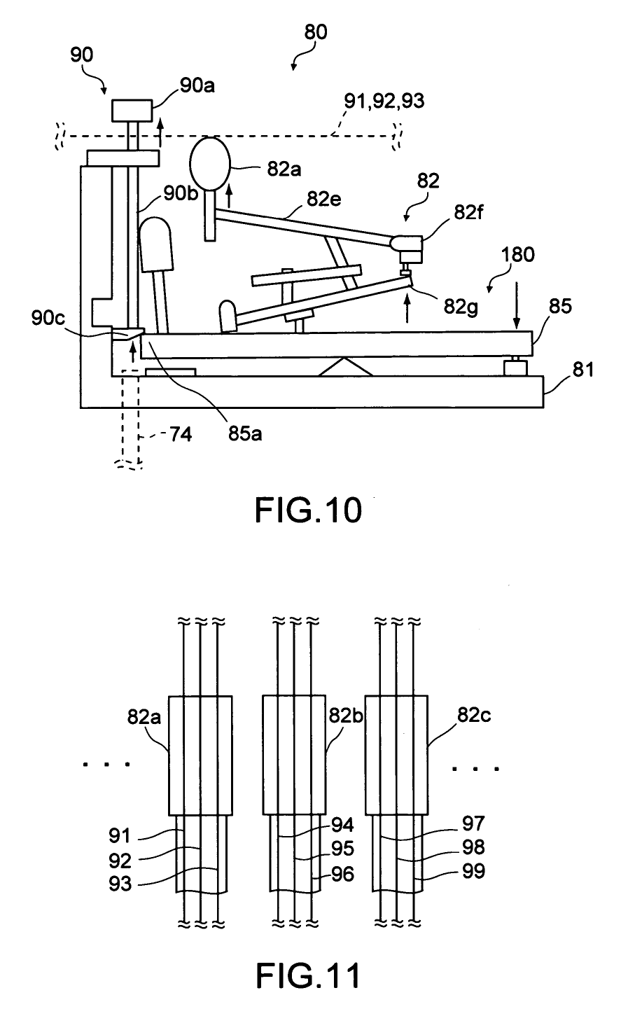

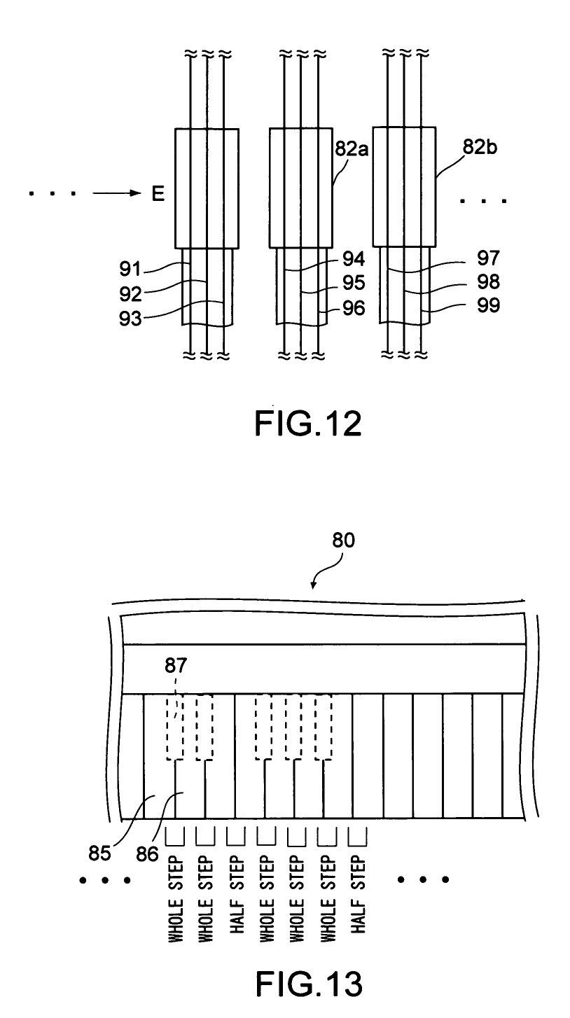

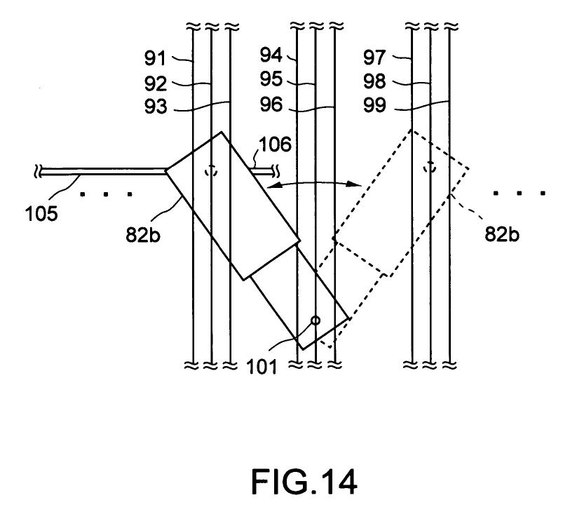

### EXPLANATION OF CODES

1, 57 . . . CPU
3, 53 . . . RAM
4, 180 . . . KEYBOARD PORTION
6 AUTOMATIC TRANSPOSITION PROGRAM MEMORY
10, 30, 100 . . . KEYBOARD INSTRUMENT
11 . . . SETTING PANEL
15, 26 . . . PERFORMANCE SUPPORT PLATE
17 . . . SUPPORT PORTION
21, 85, 86 . . . KEYBOARD
50 . . . AUTOMATIC PLAYER
52 . . . KEY TOUCH PORTION
54 . . . ROM
71 . . . DAMPER PEDAL
72 . . . FIRST PEDAL
73 . . . SECOND PEDAL
82a, 82b, 82c . . . HAMMER

What is claimed is:

1. A keyboard instrument, comprising:
a keyboard portion made only of keyboards in which tone intervals are arranged so as to repeat an arrangement of whole step, whole step, half step, whole step, whole step, whole step and half step; and
a support portion that supports the keyboard portion.

2. The keyboard instrument as set forth in claim 1,
wherein the keyboards are all in the same color.

3. The keyboard instrument as set forth in claim 1, further comprising:
a first storing means for storing an information of sounds of a piece of music;
a setting means for setting a first key information that is an information on a destination of transposition of the piece of music;
a second storing means for storing the first key information set by the setting means;
a judging means for judging a second key information that is a key of the piece of music based on the information of sounds of a piece of music stored by the first storing means; and
a transposing means for transposing sounds of the piece of the music stored by the first storing means to sounds corresponding to the first key information based on the second key information judged by the judging means.

4. The keyboard instrument as set forth in claim 1, further comprising:
a first storing means for storing an information of sounds of a piece of music and a first key information that is a key of the piece of music;
a setting means for setting a second key information that is an information on a destination of transposition of the piece of music;
a second storing means for storing the second key information set by the setting means;
a transposing means for transposing sounds of the piece of the music stored by the first storing means to sounds corresponding to the second key information based on the second key information stored by the second storing means.

5. The keyboard instrument as set forth in claim 1, further comprising:
a performance support plate that is disposed on the keyboards slidable in a plane where the keyboards are arranged.

6. The keyboard instrument as set forth in claim 1, further comprising:
a performance support plate disposed turnable so as to be attachable to or detachable from the keyboards.

7. The keyboard instrument as set forth in claim 5,
wherein the performance support plate has a black keyboard, a color keyboard, a scale keyboard or a numerical keyboard.

8. The keyboard instrument as set forth in claim 1, further comprising:
an automatic performance unit capable of being placed on the support portion:
wherein the automatic performance unit has;
a storing means for an information of a piece of music, a plurality of key touch devices disposed so as to be touchable with each of the keyboards from thereabove and a controller that control each of the key touch devices based on the information of the piece of music.

9. The keyboard instrument as set forth in claim 1, further comprising:
a vibratable string disposed corresponding to each of the keyboards;
a hammer that strikes a string in conjunction with a touched one of the keyboards;
a pedal mechanism for shifting the hammer by a half step to each of the strings.

10. The keyboard instrument as set forth in claim 9, further comprising:
a damper pedal for keeping the string vibrated once being struck with the hammer;
wherein the pedal mechanism includes;
a first pedal that is disposed on a lower pitch sound side than the damper pedal in a direction of an arrangement of the keyboards and can make sounds of the keyboard lower a half step; and
a second pedal that is disposed on a higher pitch sound side than the damper pedal in a direction of an arrangement of the keyboards and can make sounds of the keyboard higher a half step.

11. The keyboard instrument as set forth in claim 10,
wherein the hammer is capable of shifting by use of the first pedal toward a lower pitch sound side in a direction where the respective strings are arranged and by use of the second pedal toward a higher pitch sound side in a direction where the respective strings are arranged.

12. The keyboard instrument as set forth in claim 10,
wherein the hammer is capable of turning by use of the first pedal toward a lower pitch sound side around an axis substantially perpendicular to a direction where the respective strings are arranged and by use of the second pedal toward a higher pitch sound side around the axis.
